(19) United States
(12) Patent Application Publication
(10) Pub. No.: US 2026/0051703 A1
(43) Pub. Date: Feb. 19, 2026

(54) Toggle switch equipped socket

(71) Applicant: Honglin Electric Power Technology (Thailand) Co., Ltd, Rayong (TH)

(72) Inventors: Shengchao HU, Rayong (TH); Xiongbing LIU, Rayong (TH); Li YU, Rayong (TH)

(73) Assignee: Honglin Electric Power Technology (Thailand) Co., Ltd, Rayong (TH)

(21) Appl. No.: 18/803,330

(22) Filed: Aug. 13, 2024

(51) Int. Cl. H01R 13/635; H01R 13/502; H01R 24/20; H01R 105/00

(52) U.S. Cl. CPC H01R 13/635; H01R 13/502; H01R 24/20; H01R 2105/00

(57) ABSTRACT

A toggle switch equipped socket, comprising a wire; live and neutral line terminals wherein the live and neutral line terminals are provided with round holes fixedly connected with the wire, allowing a plug to be inserted into the live and neutral wire terminals; a terminal inner frame upper cover arranged outside the live and neutral wire terminals wherein the live and neutral wire terminals are able to be inserted into the terminal inner frame upper cover, and the terminal inner frame upper cover is cooperatively provided with a terminal inner frame lower cover, and the terminal inner frame lower cover; a popping mechanism installed on the terminal inner frame upper cover and the terminal inner frame lower cover, and the popping mechanism contacts the live and neutral wire terminals; and a PVC outer mold sleeved outside the terminal inner frame upper cover and the terminal inner frame lower cover.

### TECHNICAL FIELD

The present invention belongs to the technical field of sockets and more specifically relates to a toggle switch equipped socket.

### BACKGROUND TECHNOLOGY

Sockets, also known as power outlets or switch sockets, refers to seats with one or more circuit terminals into which various plugs can be inserted, facilitating connection to other circuits. Through the connection and disconnection between lines and copper components, the sockets achieve final connection and disconnection of that part of the circuits.

Although existing sockets can connect with plugs, they are unable to secure the plug firmly. Prolonged use causes loosening, leading to easy disconnection between the plugs and the sockets. Therefore, there is a need for a toggle switch equipped socket to address the aforementioned issues.

### SUMMARY OF THE INVENTION

The purpose of embodiments of the present invention is to provide a toggle switch equipped socket, aiming to solve the following problem: prolonged use of existing sockets may loosen, leading to easy disconnection between plugs and sockets.

The embodiments of the present invention are implemented as follows: a toggle switch equipped socket, comprises a wire; live and neutral line terminals, wherein the live and neutral line terminals are provided with round holes for connection with the wire, allowing a plug to be inserted into the live and neutral wire terminals for power supply; a terminal inner frame upper cover arranged outside the live and neutral wire terminals, wherein the live and neutral wire terminals are able to be inserted into the terminal inner frame upper cover, the terminal inner frame upper cover is cooperatively provided with a terminal inner frame lower cover, and the terminal inner frame lower cover and the terminal inner frame upper cover are used to protect the live and neutral wire terminals; a popping mechanism installed on the terminal inner frame upper cover and the terminal inner frame lower cover, and the popping mechanism contacts the live and neutral wire terminals, so as to push the live and neutral terminals out of the plug to unlock the plug; and a PVC outer mold sleeved outside the terminal inner frame upper cover and the terminal inner frame lower cover, wherein the PVC outer mold are provided with through holes for the popping mechanism to pass through, and the PVC outer mold is used to protect the toggle switch equipped socket entirely.

Preferably, the popping mechanism comprises at least one toggle switch rotationally mounted on an inner wall of the terminal inner frame cover and passes through the through holes provided by the PVC outer mold, on the terminal inner frame lower cover is fixedly provided at least one stainless steel spring piece, the at least one stainless steel spring piece is firmly attached to the at least one toggle switch so as to push the at least one toggle switch to rotate and reset; at least one triangular block, fixedly installed underside the at least one toggle switch, on both sides of the at least one triangular block are provided push plates, which are in slideable connection to the terminal inner frame lower cover, and the at least one toggle switch pushes the push plates on two sides away from each other through the at least one triangular block to release the live and neutral line terminals from the plug.

Preferably, the toggle switch equipped socket further comprises a ground wire inner frame arranged in the PVC outer mold and fixedly connected to a lower end portion of the terminal inner frame lower cover, wherein in the ground wire inner frame is provided a ground wire terminal, and the ground wire terminal is connected to a ground wire for grounding the plug.

The toggle switch equipped socket provided by the present invention not only locks a plug into the socket, but also allows for quick separation of the plug and the socket by setting the popping mechanism, which is simple to use and highly practical.

### BRIEF DESCRIPTION OF THE DRAWINGS

FIG. 1 is a schematic diagram of appearance of a toggle switch equipped socket.

FIG. 2 is a schematic diagram of a terminal inner frame upper cover and a terminal inner frame lower cover of the toggle switch equipped socket.

FIG. 3 is a schematic diagram showing an internal structure of the toggle switch equipped socket.

FIG. 4 is a front view showing the internal structure of the toggle switch equipped socket.

FIG. 5 is a rear view showing the internal structure of the toggle switch equipped socket.

The markups in the drawings are indicates as follows:
1—wire;
2—live and neutral line terminal;
3—terminal inner frame upper cover;
4—terminal inner frame lower cover;
5—popping mechanism;
6—PVC outer mold;
51—toggle switch;
52—stainless steel spring piece;
53—triangular block;
54—push plate;
7—ground wire inner frame; and
8—ground wire terminal.

### SPECIFIC EMBODIMENTS

In order to make the purpose, technical solution and advantages of the present invention more clear, the present invention is further described in detail below in conjunction with the accompanying drawings and embodiments. It should be understood that the specific embodiments described here are only used to explain the present invention and do not limit the present invention.

The specific implementation of the present invention is described in detail below in conjunction with specific embodiments.

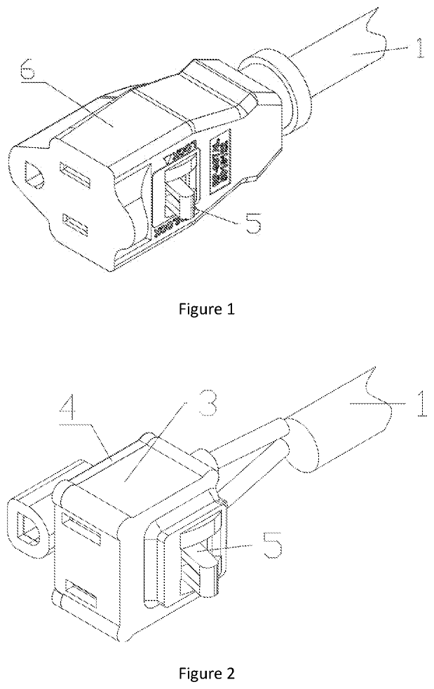

Please refer to FIGS. 1-3, an embodiment of the present invention provides a toggle switch equipped socket and the toggle switch equipped socket comprises a wire 1; live and neutral line terminals 2, wherein the live and neutral line terminals 2 are provided with round holes fixedly connected with the wire 1, allowing a plug to be inserted into the live and neutral wire terminals 2 for power supply; a terminal inner frame upper cover 3 arranged outside the live and neutral wire terminals 2, wherein the live and neutral wire terminals 2 are able to be inserted into the terminal inner frame upper cover 3, the terminal inner frame upper cover 3 is cooperatively provided with a terminal inner frame lower cover 4, and the terminal inner frame lower cover 4 and the terminal inner frame upper cover 3 are used to protect the live and neutral wire terminals 2; a popping mechanism 5 installed on the terminal inner frame upper cover 3 and the terminal inner frame lower cover 4, and the popping mechanism 5 contacts the live and neutral wire terminals 2, so as to push the live and neutral terminals 2 out of the plug to unlock the plug; and a PVC outer mold 6 sleeved outside the terminal inner frame upper cover 3 and the terminal inner frame lower cover 4, wherein the PVC outer mold 6 are provided with through holes for the popping mechanism 5 to pass through and the PVC outer mold 6 is used to protect the toggle switch equipped socket entirely.

In the present embodiment, the live and neutral line terminals 2 are provided with protrusions fitting into holes on the plug, thereby securing the plug to the toggle switch equipped socket.

When the toggle switch equipped socket is used, the wire 1 and a power supply is connected, a plug is inserted from the PVC outer mold 6 into the terminal inner frame upper cover 3 and the terminal inner frame lower cover 4, the protrusions on the live and neutral line terminals 2 then enter holes on the plug, thus securing the connection between the plug and the toggle switch equipped socket; when the plug is unplugged, the popping mechanism 5 is toggled, which disengages the protrusions on the live and neutral line terminals 2 from the holes in the plug, allowing the plug to be removed; after unplugging, the popping mechanism 5, which will automatically reset under its own spring force, and the live and neutral line terminals 2 will also reset under its own spring force.

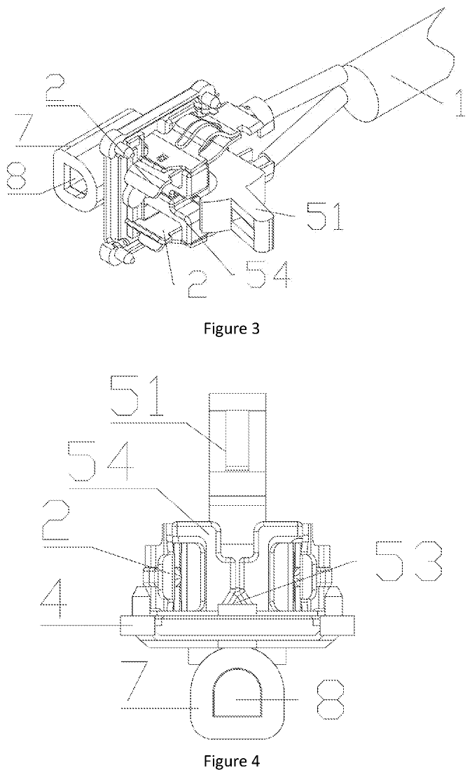

As shown in FIGS. 3-5, in a preferable embodiment of the present invention, the popping mechanism 5 comprises at least one toggle switch 51 rotationally mounted on an inner wall of the terminal inner frame cover 3 and passes through the through holes provided by the PVC outer mold 6, on the terminal inner frame lower cover 4 is fixedly provided at least one stainless steel spring piece 52, the at least one stainless steel spring piece 52 is firmly attached to the at least one toggle switch 51 so as to push the at least one toggle switch 51 to rotate and reset; at least one triangular block 53 fixedly installed underside the at least one toggle switch 51, on both sides of the at least one triangular block 53 are provided push plates 54, which are in slidable connection to the terminal inner frame lower cover 4, and the at least one toggle switch 51 pushes the push plates 54 on two sides away from each other through the at least one triangular block 53 to release the live and neutral line terminals 2 from the plug.

When it needs to unplug the plug, the at least one toggle switch 51 is toggled, the at least one toggle switch 51 rotates on the terminal inner frame upper cover 3 and simultaneously pushes the at least one stainless steel spring piece 52 to generate a reset spring force, rotation of the at least one toggle switch 51 drives the at least one triangular block 53 to move upward, thereby pushing the push plates 54 on both sides away from each other, the push plates 54 then disengage the protrusions on the live and neutral line terminals 2 from the holes in the plug, allowing the plug to be removed; after unplugging, the at least one toggle switch 51 is released, and the at least one stainless steel spring piece 52 actuates the at least one toggle switch 51 to rotate back to an original position thereof, and the live and neutral line terminals 2 will also reset under own spring force thereof.

In the present embodiment, another design option could be adopted, that is to say, the at least one toggle switch 51 with at least one button, the at least one triangular block 53 changes orientation thereof and directly fixes to the at least one button, simultaneously, the at least one stainless steel spring piece 52 is replaced with at least one spring, with both ends of the at least one spring fixed to the at least one button and the terminal inner frame lower cover 4; when the at least button is released, the at least one spring actuates the at least one button to reset, by pressing the at least one button, the at least one triangular block is pushed downward, so as to push the push plates 54 on both sides away from each other, the push plates 54 then disengages the protrusions on the live and neutral line terminals 2 from the holes in the plug, allowing the plug to be removed; furthermore, on the push plates are provided protective doors to control the opening and closing of socket slots, and when the at least one button is presses, the push plates 54 on both sides move away from each other, thereby disengaging the protective doors to close the socket slots, preventing electric shock and foreign object entry, and ensuring child safety.

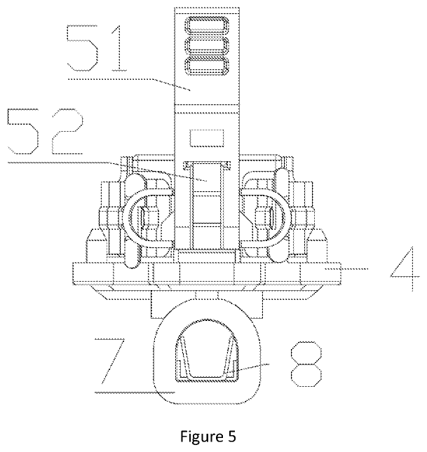

As shown in FIGS. 4-5, in a preferable embodiment of the present invention, the toggle switch equipped socket further comprises a ground wire inner frame 7 arranged in the PVC outer mold 6 and fixedly connected to a lower end portion of the terminal inner frame lower cover 4, wherein in the ground wire inner frame 7 is provided a ground wire terminal 8, and the ground wire terminal 8 is connected to a ground wire for grounding the plug.

The plug is inserted into the toggle switch equipped socket, so as to connect with the ground wire terminal 8, thus grounding the plug and ensuring electrical safety.

The above are only preferred embodiments of the present invention and are not intended to limit the present invention. Any modifications, equivalent substitutions and improvements made within the spirit and principles of the present invention should be included in the protection scope of the present invention.

1. A toggle switch equipped socket, comprising:
a wire;
live and neutral line terminals, wherein the live and neutral line terminals are provided with round holes for fixed connection with the wire, allowing a plug to be inserted into the live and neutral wire terminals for power supply;
a terminal inner frame upper cover arranged outside the live and neutral line terminals, wherein the live and neutral line terminals are able to be inserted into the terminal inner frame upper cover, the terminal inner frame upper cover is cooperatively provided with a terminal inner frame lower cover, and the terminal inner frame lower cover and the terminal inner frame upper cover are used to protect the live and neutral line terminals;
a popping mechanism installed on the terminal inner frame upper cover and the terminal inner frame lower cover, and the popping mechanism contacts the live and neutral line terminals, so as to push the live and neutral line terminals out of the plug to unlock the plug;
and a PVC outer mold sleeved outside the terminal inner frame upper cover and the terminal inner frame lower cover, wherein the PVC outer mold are provided with through-holes for the popping mechanism to pass through, and the PVC outer mold is used to protect the toggle switch equipped socket entirely.

2. The toggle switch equipped socket according to claim 1, wherein the popping mechanism comprises at least one toggle switch rotationally mounted on an inner wall of the terminal inner frame cover and passes through the through holes provided by the PVC outer mold, on the terminal inner frame lower cover is fixedly provided at least one stainless steel spring piece, the at least one stainless steel spring piece is firmly attached to the at least one toggle switch so as to push the at least one toggle switch to rotate and reset; and
at least one triangular block, fixedly installed underside the at least one toggle switch, on both sides of the at least one triangular block are provided push plates, which are in slideable connection to the terminal inner frame lower cover, and the at least one toggle switch push the push plates on two sides away from each other through the at least one triangular block to release the live and neutral line terminals from the plug.

3. The toggle switch equipped socket according to claim 1, further comprising a ground wire inner frame arranged in the PVC outer mold and fixedly connected to a lower end portion of the terminal inner frame lower cover, wherein in the ground wire inner frame is provided a ground wire terminal, and the ground wire terminal is connected to a ground wire for grounding the plug.
